(19) United States
(12) Patent Application Publication
(10) Pub. No.: US 2010/0089818 A1
(43) Pub. Date: Apr. 15, 2010

(54) DEVICE FOR PURIFYING GASES, SUCH AS AIR IN PARTICULAR, OR LIQUIDS, SUCH AS WATER IN PARTICULAR

(76) Inventor: Bonno KOERS, HR Doesburg (NL)

Correspondence Address: FOLEY AND LARDNER LLP;SUITE 500, 3000 K STREET NW, WASHINGTON, DC, 20007, US

(21) Appl. No.: 12/574,316

(22) Filed: Oct. 6, 2009

(30) Foreign Application Priority Data
Oct. 13, 2008 (NL) 1036062

(51) Int. Cl. B01D 39/16

(52) U.S. Cl. 210/488; 55/527

(57) ABSTRACT

Device for purifying gases, such as air in particular, or liquids, such as water in particular, in which use is made of micro-organisms. The device comprises a chamber (1) containing at least one filter pattern (7) and having intakes and outlets (12, 13) for the medium that is to be purified. The filter pattern is obtained by making use of virtually two-dimensional geo-textile (8) made from sprayed plastic threads with a thickness of approximately 2 mm for retaining the micro-organisms, and a three-dimensional geo-textile (9) with a thickness of approximately 10 mm, allowing the medium that is to be treated to flow alongside the micro-organisms. The geotextile materials (8, 9) are placed on top of each other and jointly rolled up to form the filter pattern (7). The geo-textile material may for instance be made of HDPE or polypropylene.

### CROSS-REFERENCE TO RELATED PATENT APPLICATIONS

The right of foreign priority is claimed under 35 U.S.C. § 119(a) based on The Netherlands Application No. 1036062, filed Oct. 13, 2008, the entire contents of which, including the specification, drawings, claims and abstract, are incorporated herein by reference.

### BACKGROUND OF THE INVENTION

The invention relates to a device for purifying gases, such as air in particular, or liquids, such as water in particular, in which use is made of micro-organisms, which device comprises a chamber having intakes and outlets for the medium that is to be purified, in which chamber filter material is present, comprising means for absorbing micro-organisms.

A device of this type is known from NL-A-10106010. In that known device a first mat is used that is made of foamed plastic material, and placing in between a second mat that serves as a support and that consists of at least partially undulated worked open plastic material, such that between the parts of the first mat, following each other in radial direction, due to the presence of the second mat, a certain distance remains free and the jointly rolled-up mats as a filter pattern fitting in a support construction can be added.

It was found that the mat that consists of foamed plastic material and is provided with large open pores does have good adhesive properties for micro-organisms, but that this adhesion mainly takes place on the outer surface of the foamed plastic mat. In this mat specifically water and rest products of the micro-biological process heap up. Due thereto, the further thickness of the foam mat hardly contributes to the purifying effect of the total system that it was originally assumed to have.

### SUMMARY OF THE INVENTION

Furthermore it was found that the mat, which consists of foamed plastic material, due to the retention of water, micro-organisms and the rest products of the micro-organisms becomes so heavy that the foamed mat sags in under its own weight, as a result of which the medium that is to be treated can hardly penetrate the foamed plastic mat. The entirety of the construction because of that creates a greater resistance for the medium flowing through the device.

Of the filter pattern as a whole therefore a considerable part of the cross-section surface cannot contribute to the purifying effect of the device.

The invention provides that the means for retaining the operational micro-organisms are comprised by virtually two-dimensionally sprayed plastic threads and three-dimensionally sprayed plastic threads with a thickness of between 0.2 and 2 mm, which two and three-dimensionally sprayed plastic threads each form a geo-textile.

The virtually two-dimensional geo-textile comprises the walls of the plastic three-dimensional geo-textile. This thus created wall creates a great surface for retaining the microorganisms. The three-dimensional geo-textile located between the walls, in addition to the retention of the micro-organisms creates a spatial structure allowing a proper flow of the medium that is to be purified.

A complete filter package can be obtained by wrapping the combined geo-textiles, or by placing plates of sprayed geo-textile behind each other. The packages are subsequently placed in a chamber with an intake and an outlet opening.

This combination of geo-textile elements occupies much less space than the foamed plastic material, so that the purifying effect of the entire device per surface unit of the cross-section of the filter material is improved considerably. The spatial construction of the sprayed threads retains no water or residual substances of micro-organisms. In addition to a considerably smaller pressure reduction in the filter package, also the weight thereof is considerably less. The lower weight, in combination with the more rigid construction, also leads to it that this construction does not sag in anymore.

The two geo-textiles may be manufactured by for instance using HDPE or polypropylene sprayed as threads, which threads are sprayed in structure over each other so as to form the aforesaid “geo-textile”. Such materials are available on the market.

According to the invention the thickness of the two-dimensional geo-textile will approximately be 2 mm, whereas the thickness of the three-dimensional geo-textile specifically will be between 6 and 14 mm and more specifically approximately 10 mm.

Further objects, features and advantages of the present invention will become apparent from the detailed description of preferred embodiments that follows, when considered together with the accompanying figures of drawing.

### BRIEF DESCRIPTION OF THE DRAWINGS

The invention is further explained by means of the attached drawings, in which:

FIG. 1 diagrammatically shows a partial cross-section of a device according to the invention;

FIG. 2 diagrammatically shows a top view of a device according to the invention, at an enlarged scale, and;

FIG. 3 diagrammatically shows a perspective view of the geo-textile of FIG. 2.

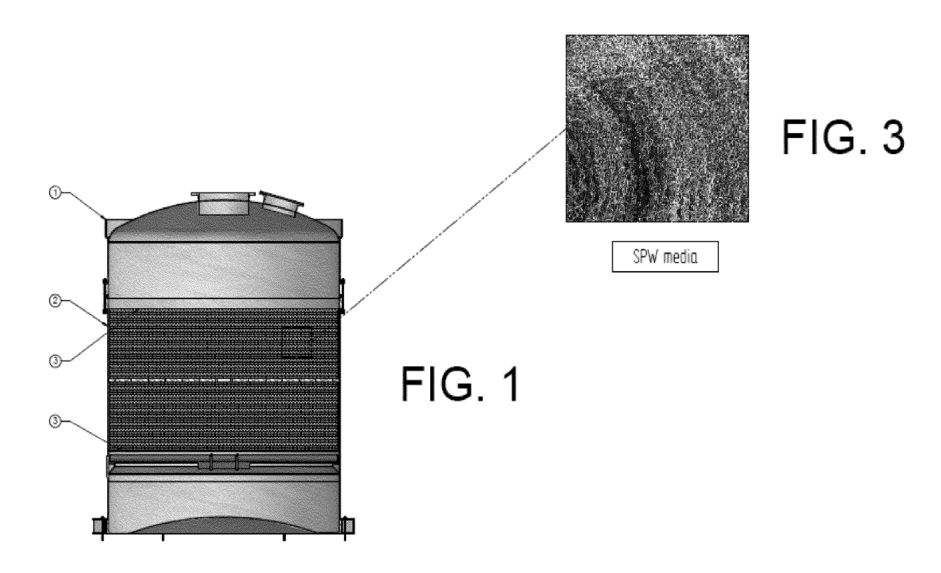

### DETAILED DESCRIPTION OF THE PREFERRED EMBODIMENTS

The device according to the invention in the known manner comprises a cylindrical chamber 1, closed off by a base plate 2, and at its top side by a lid 3.

Within the chamber 1 there are three filter elements 4, each constituted by a pipe 5, being provided with a framework 6 at its bottom side, and which tube accommodates a filter pattern 7.

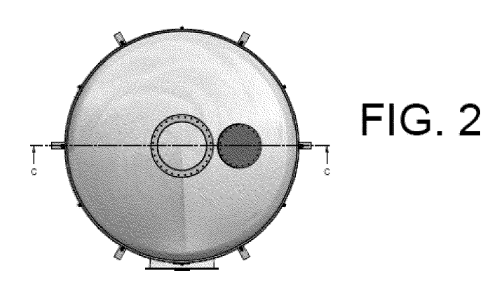

The filter pattern 7 is obtained by rolling up a virtually two-dimensional geo-textile 8, together with a three-dimensional geo-textile 9, as shown in the FIGS. 2 and 3.

The composition of the layers geo-textile 8 and 9 has already been described hereinabove, so that it does not require any further explanation here.

At its bottom side, the chamber 1 is provided with an air intake 12 and at the top side with an air outlet 13.

Above the top side of chamber 1 a conduit 14 is provided with one or more spray nozzles 15, whereas at the bottom side of the chamber 1 the sprayed-on water is discharged by means of a conduit 16.

It is noted here that it is not absolutely necessary to use the tube 5 for taking up the filter pattern 7. It can also be fitted directly in the chamber 1. It is also possible to affix the various types of geo-textile directly in the chamber.

It will be obvious that only one single possible embodiment of a device according to the invention has been illustrated in the drawing and has been described above, and that many changes can be made without being beyond the inventive idea as it is defined in the claims.

What is claimed is:

1. Device for purifying gases, such as air in particular, or liquids, such as water in particular, in which use is made of micro-organisms, which device comprises a chamber having intakes and outlets for the medium that is to be purified, in which chamber filter material is present, comprising a means for absorbing micro-organisms, with the characteristic that the means for retaining the operational micro-organisms are comprised by virtually two-dimensionally sprayed plastic threads and three-dimensionally sprayed plastic threads with a thickness of between 0.2 and 2 mm, which two and three-dimensionally sprayed plastic threads each form a geo-textile.

2. Device according to claim 1, characterized therein that the thickness of the two-dimensional geo-textile approximately is 2 mm, and the thickness of the three-dimensional geo-textile specifically lies between 6 and 14 mm and more specifically is approximately 10 mm.

3. Device according to claim 1, characterized therein that the geo-textile is made of HDPE or propylene.

4. Device according to claim 2, characterized therein that the geo-textile is made of HDPE or propylene.
